(19) United States
(12) Patent Application Publication
(10) Pub. No.: US 2005/0132835 A1
(43) Pub. Date: Jun. 23, 2005

(54) Transfer driven gear

(76) Inventor: Myoung Hun Kang, Yongin-city (KR)

Correspondence Address: MORGAN, LEWIS & BOCKIUS LLP (SF), 2 PALO ALTO SQUARE, PALO ALTO, CA, 94306, US

(21) Appl. No.: 11/016,211

(22) Filed: Dec. 17, 2004

(30) Foreign Application Priority Data
Dec. 18, 2003 (KR) 10-2003-0093220

(51) Int. Cl. F16H 31/00; F16H 55/17

(52) U.S. Cl. 74/434

(57) ABSTRACT

A transfer driven gear according to an embodiment of the present invention includes a shaft-hole formed in a center thereof, a plurality of gear teeth formed on an outer circumference thereof, and a rib formed between the shaft-hole and the gear teeth. At least one air exhausting hole is formed on the rib such that air overheated during heat treatment can be exhausted through the at least one air exhausting hole.

### CROSS-REFERENCE TO RELATED APPLICATIONS

This application claims priority of Korean Application No. 10-2003-0093220, filed Dec. 18, 2003, the disclosure of which is incorporated herein by reference.

### FIELD OF THE INVENTION

Generally, the present invention relates to a transfer driven gear. More particularly, the present invention relates to the transfer driven gear which has smaller weight and reduced deformation in a heat treatment.

### BACKGROUND OF THE INVENTION

Generally, an automatic transmission has a mid-shaft for transferring torque converted by a shift-ratio of a main shift-range to a differential which is a final decelerating apparatus. For this purpose, a transfer gear set, which is a first decelerating apparatus, is utilized. However, this weight of the transfer gear set and deformation that can occur during the heat treatment used while making the transfer gear set, affects performance and quality of the automatic transmission.

As shown in FIGS. 1 and 2, a parking gear 11 is additionally manufactured on the transfer driven gear (forging type) and the parking gear 11 makes the transfer driven gear heavier too.

As described, the performance and quality of the transfer driven gear are greatly affected by the deformation during a heat treatment process.

On the other hand, a twist is occurred throughout the whole conventional transfer driven gear 10 because an air trap is occurred in a part A during the heat treatment process.

The twist is a cause of noise and a reduction of strength because the twist affects an array of the transfer driven gear.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

Embodiments of the present invention provide a transfer driven gear having non-limiting advantages of reduced weight and reduced deformation which may be occurred in a heat treatment process.

An exemplary transfer driven gear according to an embodiment of the present invention includes: a shaft-hole formed in a center thereof; a plurality of gear teeth formed on an outer circumference thereof; and a rib formed between the shaft-hole and the gear teeth, wherein at least one air exhausting hole is formed on the rib such that air overheated during a heat treatment process is exhausted through the at least one air exhausting hole.

In a further embodiment, the transfer driven gear includes: a parking gear formed on one side of the rib; and the at least one air exhausting hole is formed as a plurality of holes, wherein at least one of the plurality of air exhausting holes is formed inside of the parking gear and at least one of the plurality of air exhausting holes is formed outside of the parking gear.

In another further embodiment, on the transfer driven gear the at least one air exhausting hole is formed as a plurality, and the plurality of air exhausting holes are radially formed.

In another further embodiment, on the transfer driven gear a parking gear is formed on one side of the rib and grooves for reducing weight are formed on an inner surface of the parking gear.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a perspective view showing a scheme of the transfer driven gear according to an embodiment of the present invention; and

FIG. 2 is a sectional view along line A-A of FIG. 1 according to an embodiment of the present invention.

### DETAILED DESCRIPTION OF THE PREFERRED EMBODIMENTS

An embodiment of the present invention will hereinafter be described in detail with reference to the accompanying drawings.

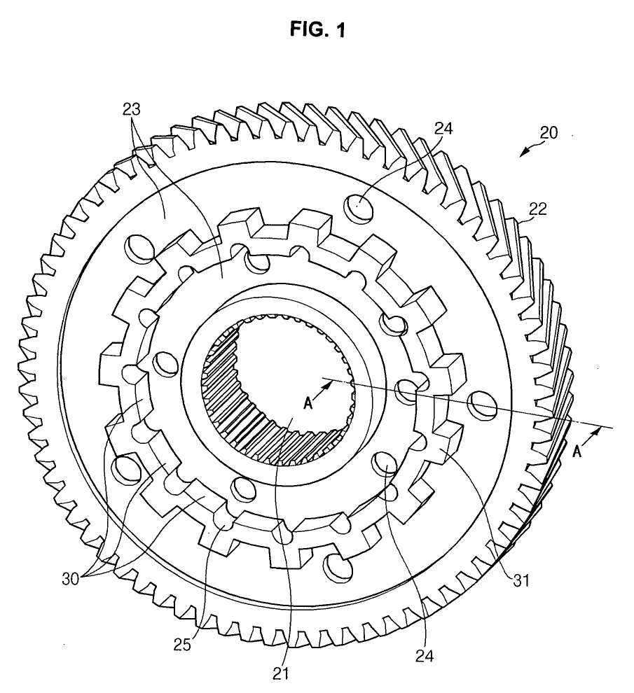

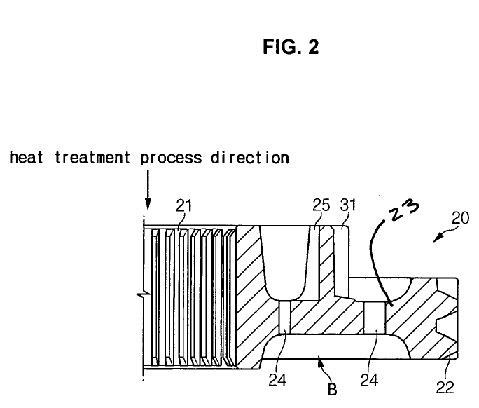

As shown in FIGS. 1 and 2, a transfer driven gear 20 may include: a shaft-hole 21 formed in a center thereof for an receiving a shaft; a plurality of gear teeth 22 formed on an outer circumstance thereof; and a rib 23 formed between the shaft-hole 21 and the gear teeth 22. The transfer driven gear 20 is installed in a transfer gear set for transferring a torque converted by a shift-ratio of a main shift-range to a differential which is a final decelerating apparatus.

At least one air exhausting hole 24 is formed on the rib 23 such that air overheated during heat treatment is exhausted through the at least one air exhausting hole 24. The heat treatment process is for manufacturing the transfer driven gear 20 and is a heating and cooling treatment for changing a metal tissue and quality of the transfer driven gear 20.

Because the heat treatment process will be understood by persons having ordinary skill in this technical field, further explanation of the same is omitted.

In one embodiment, a parking gear 31 may be formed on one side of the rib 23. In this case, the at least one air exhausting hole 24 is formed as a plurality of holes, wherein at least one of the plurality of air exhausting holes 24 is formed inside of the parking gear 31. At least one of the plurality of air exhausting holes 24 is also formed outside of the parking gear 31.

The parking gear 31 is used for parking a vehicle. It will be well understood by persons having ordinary skill in this technical field as to how the parking gear functions, so further explanation of the same is omitted.

As shown in FIG. 1, the at least one air exhausting hole 24 is preferably formed as a plurality, and the plurality of air exhausting holes 24 are radially formed but the location and number of the air exhausting holes 24 are not limited.

In an alternative embodiment, grooves 25 for reducing weight of the transfer driven gear 20 may be formed on an inner surface 30 of the parking gear 31 of the transfer driven gear 20. The grooves 25 are preferably formed into a half circle type but other shapes may be used.

Performance of a transfer driven gear 20 according to an embodiment of the present invention is described hereinafter.

According to an embodiment of the present invention, a motivation for the present invention is to provide a high-quality automatic transmission by improving the transfer driven gear which greatly affects a performance and quality of an automatic transmission. Thus, one advantage of the present invention is to prevent twist throughout the whole transfer driven gear 20 resulting from air that might otherwise be trapped at B, under rib 23, during the heat treatment process.

The air exhausting holes 24 for exhausting overheated air are formed in the rib 23 of the transfer driven gear 20. Therefore, the air trap in the part B does not occur. In addition, the weight of the transfer driven gear 20 can be reduced by enlarging a size of the air exhausting holes 24 to a scope that does not affect strength of the transfer driven gear 20.

In this case, a noise problem, which is one of the most important things in transmission development, can be solved. That is, a main cause of the noise problem is the twist occurring throughout the whole of transfer driven gear 20 after the heat treatment process. The noise problem can be solved because a lesser deformation in the heat treatment process makes a more uniform shape of the gear teeth 22 according to an embodiment of the present invention.

The grooves 25 which are formed in the parking gear 31 are enlarged to a size that does not affect a strength of the parking gear 31.

The transfer driven gear 20 may be manufactured by forging, therefore the present invention may be realized only by a simple modification of a die-casting metallic pattern without raising the manufacturing costs.

As described above, the transfer driven gear advantages according to an embodiment of the present invention are described hereinafter.

A noise problem may be solved because a deformation by heat treatment is reduced, drivability is improved, and a weight is reduced by grooves of a parking gear and air exhausting holes for preventing a deformation during heat treatment process.

In addition, damping and intercepting parts for reducing noises can be reduced because of noise reduction.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A transfer driven gear including:
a shaft-hole formed in a center thereof for receiving a shaft;
a plurality of gear teeth formed on an outer circumference thereof; and
a rib formed between the shaft-hole and the gear teeth, wherein at least one air exhausting hole is formed on the rib such that air overheated during a heat treatment process can be exhausted through the at least one air exhausting hole.

2. The transfer driven gear of claim 1, wherein a parking gear is formed on one side of the rib and the at least one air exhausting hole is formed as a plurality of holes, and wherein at least one of the plurality of air exhausting holes is formed inside of the parking gear and at least one of the plurality of air exhausting holes is formed outside of the parking gear.

3. The transfer driven gear of claim 1, wherein the at least one air exhausting hole is formed as a plurality of holes, and the plurality of air exhausting holes are radially positioned.

4. The transfer driven gear of claim 1, wherein a parking gear is formed on one side of the rib and grooves for reducing weight are formed on an inner surface of the parking gear.
